(19) United States
(12) Patent Application Publication
(10) Pub. No.: US 2024/0278282 A1
(43) Pub. Date: Aug. 22, 2024

(54) SINGLE POINT IMPREGNATION

(71) Applicant: Godfrey & Wing, LLC, Aurora, OH (US)

(72) Inventors: Troy Sutton, Aurora, OH (US); Adam Haviland, Aurora, OH (US); Mark Donahue, Aurora, OH (US); John Halladay, Aurora, OH (US)

(73) Assignee: Godfrey & Wing, LLC, Aurora, OH (US)

(21) Appl. No.: 18/444,095

(22) Filed: Feb. 16, 2024

Related U.S. Application Data
(60) Provisional application No. 63/446,303, filed on Feb. 16, 2023.

(51) Int. Cl. B05D 7/14; B05D 7/24

(52) U.S. Cl. CPC B05D 7/14; B05D 7/24; B05D 2202/20; B05D 2401/20

(57) ABSTRACT

A method and system are disclosed for impregnating a porosity of a part with sealant without immersing the part in sealant or using a known batch process. At least one fill source and at least one drain source are connected to the part, wherein the fill source and drain source are each in communication with a porosity of the part. In one aspect a vacuum is applied through the fill source and through the porosity, and sealant is then released into the porosity. Pressure can be applied to the porosity after the sealant is released into the porosity to assist in pushing the sealant into the porosity. Excess uncured sealant can be removed by injecting water into the porosity and then drawing out the water with the excess sealant. Heated water may be introduced into the porosity to cure the sealant if the sealant requires heat to cure.

### CROSS-REFERENCE TO RELATED APPLICATIONS

This application claims priority to and incorporates by reference U.S. Provisional Application No. 63/446,303 filed on Feb. 16, 2023.

### BACKGROUND

Sealing the porosity of parts, including aluminum or magnesium parts, is normally done by moving the part to a batch sealant line after the part is cast or otherwise produced. At the sealant line the part typically has a vacuum applied to it and is then immersed in sealant in a tank or chamber. The sealant is drawn into the part by the vacuum, and then a pressure is typically applied to the sealant tank or chamber to further push sealant into the part's porosities. The sealant is drained from the sealant chamber, or the part is removed from the sealant tank or chamber, and the part is then washed and rinsed to remove excess sealant from its outside surface. The part may then be moved to a curing station at which heat is applied and the sealant inside the part's porosities is cured. Or, the sealant, such as an anaerobic sealant, may cure without heat being applied.

The following are incorporated herein by reference: U.S. patent application Ser. No. 18/464,831 filed on Sep. 11, 2023; U.S. Provisional Ser. No. 63/459,632 filed on Apr. 14, 2023; U.S. patent Ser. No. 18/196,488 filed on May 12, 2023; and U.S. patent application Ser. No. 18/481,114 filed on Oct. 4, 2023.

### SUMMARY

This application discloses a single point sealant impregnation (SPI) system and method that eliminates the need for a sealant processing line and a batch sealant process. In an embodiment it utilizes two or more connections to a part to be sealed, in which the two or more connections apply vacuum, sealant, pressure, water, and/or air into the part body, and include one or more returns, thereby using the part itself as the process chamber, rather than moving the part from chamber to chamber or tank to tank in which the part is treated. The SPI process and system of this disclosure injects multiple process fluids (fluid means liquid and gas, such as air) preferably passed through two or more connection points on the part, wherein at least one connection is to a fill (or input) point on the part and is connected to one or more first fluid lines, and at least one connection is preferably a drain (or output) point on the part and is connected to at least one second fluid line.

One of the advantages of this SPI system is that, rather than immerse the entire part into the sealant and water at different process steps, process fluids are only applied to the internal potential leak paths of the part and the part need not be moved during processing. With current batch impregnation operations, parts to be sealed must be handled at least three times to move them to at least three process modules, and sometimes handled as many as eight times. Utilizing the methods and systems of present disclosure, the material handling aspect of the known batch processes are eliminated, generating a reduced cycle (TAKT, which is a calculation of the available production time divided by customer demand) time for parts. Additionally, the overall footprint of the system is much smaller, and not much larger than the part itself and the relatively small, related infrastructure required to seal the porosities in the part. No chambers or tanks, and the relatively large infrastructure related to them, are required. The overall system size according to this disclosure may be approximately ten-twelve times or more smaller than a comparable batch system.

Utility usage is also reduced using the teachings of this disclosure. Rather than having large storage tanks (such as between 135-3,800 gallons) that must be maintained at relatively high temperatures and monitored for batch processes, only the materials needed immediately for a given part or parts are used at one time. Thus, the SPI process of this disclosure is efficient with relatively little material waste.

Further, sealant does not coat the outside of the part when the SPI process of this disclosure is used because the part is not immersed in the sealant. This eliminates the need for external washing and/or rinsing and reduces the risk of sealant entering and contaminating tapped holes in the part because the outside surface of the part is not immersed in sealant. Sealant is introduced into the leak paths (e.g., the porosities) themselves of a part rather than the part being immersed in the sealant.

Some parts can also be processed after being fully assembled using the SPI process of this disclosure. For example, a battery pack that has been assembled with batteries, electrical connections, etc., is a candidate for this SPI process because the batteries are not directly subject to, for example, the approximately 195° F. (90° C.) curing temperatures of some types of sealant. If a battery pack with batteries and circuitry was immersed in sealant and then washed/rinsed and heat cured in a chamber or tank the batteries and/or circuitry could be damaged.

As used herein, cross linking, cross polymerization, and curing are used interchangeably to mean curing a liquid sealant into a solid. As used herein, “sealant,” “resin,” and “polymer” are used interchangeably.

### BRIEF DESCRIPTION OF THE DRAWINGS

FIG. 1 is a front, perspective view of a system according to this disclosure.

FIG. 2 is a schematic diagram of a single point impregnation system according to this disclosure.

FIG. 3 is a partial, side perspective view of a part with connections on it in order to inject and remove fluid into the part's porosities.

FIG. 4 is a top sectional view of the part of FIG. 3 showing the fluid flow inside of the part.

FIG. 5 is a side, perspective view of another part having inlets for fluid (liquid or gas) to enter the part and outlets for fluid to exit the part.

FIG. 6 is a side, perspective view of another part on a processing table and of manifolds that may be used in a system and process according to this disclosure.

FIG. 7 is a close-up, partial, top, perspective view of the part of FIG. 6.

FIG. 8 is a partial, perspective view of the manifolds of the system of FIG. 6.

FIG. 9 is a top, perspective view of an alternate system according to this disclosure.

FIG. 10 is a close-up, side perspective view of the valve tree of the system of FIG. 9.

FIG. 11 is a side, partial sectional view of a VDA (Verband der Automobilindustrie) connector according to this disclosure.

### DETAILED DESCRIPTION

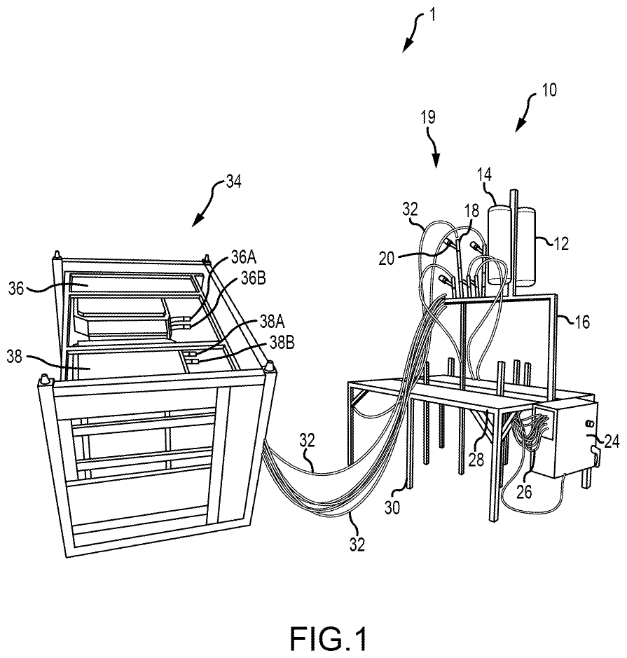

Turning now to the Figures, wherein the purpose is to describe embodiments of this disclosure and not to limit same, FIG. 1 shows a system 1 that includes an apparatus 10 and a dunnage, or carrier, 34 that contains two parts 36, 38, although a dunnage could include any number of parts. The dunnage 34 in this example is 8′×4′×4′ and parts 36, 38 may be processed without removing them from the dunnage 34, i.e., no removal of the parts 36, 38 is required prior to sealing them. In this example, system 10 has a first container 12 that holds compressed air, and a second container 14 that also holds compressed air, so no shop air need be used. A frame 16 supports containers 12, 14 and a valve tree 19. Frame 16 is part of table or support 28 having legs 30. Frame 16, support 28, and legs 30 can be any suitable structure for supporting containers 12, 14, and valve tree 19.

Valve tree 19 includes lines, including lines 32, that are connected to tanks of pressurized air 12, 14 and to a sealant source, vacuum source, a water source, and optionally a hot water source (all not shown here) by lines that communicate with valves 20 and piping 18 in valve tree 19. The lines are connected (not shown in FIG. 1) to fill points (or input ports) 36A, 38A and to drainage points (or exit ports) 36B, 38B, respectively on parts 36, 38.

Circuit box 24 contains circuitry that powers and controls system 10, including the timing and duration of SPI process steps and the injection and removal of process fluids (liquid and gas). Wired connector 26 provides power and electronic signals to valves 20.

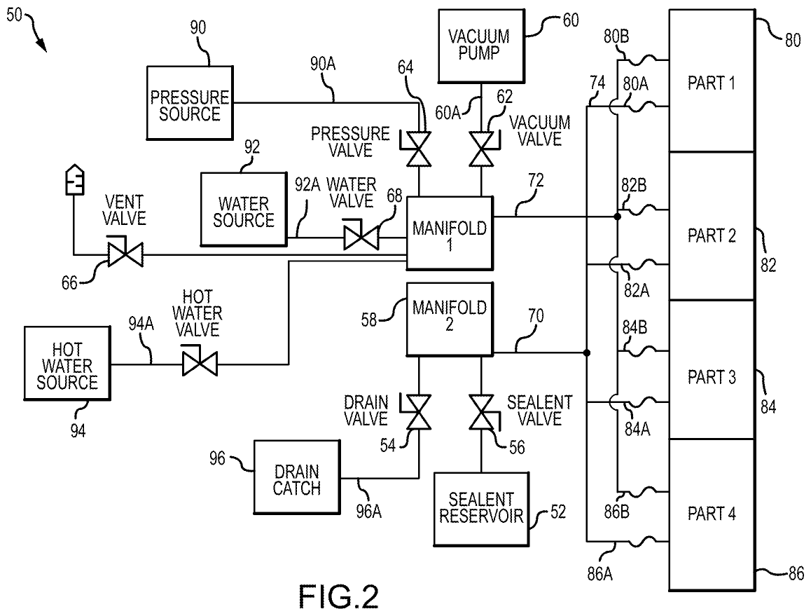

FIG. 2 shows an example schematic of an SPI piping and instrumentation diagram (P&ID) of a system that can process four parts at one time, although a system and process according to this disclosure could process any number of parts.

System 50 includes a vacuum pump 60 that applies a vacuum through line 60A and the passage of the sealant is controlled by vacuum valve 62. Vacuum valve 62 does not apply the vacuum to second manifold 64 when vacuum valve 62 is closed. Vacuum is applied to first manifold 64 when vacuum valve 62 is open. When vacuum is applied to first manifold 64 the vacuum is directed through line 72 to common line 74, and into each input line 80A, 82A, 84A, and 86A, respectively and applied to parts 80, 82, 84, and 86.

A pressure source 90 applies pressure through a line 90A. Pressure source 90 is preferably pressurized air that can be delivered by a self-contained source, such as a tank or pump, or by shop air. Pressure valve 64 does not apply the pressure to first manifold 64 when pressure valve 64 is closed. Pressure is applied to first manifold 64 when pressure valve 64 is open. When pressure is applied to first manifold 64 the pressure is directed through line 72 to common line 74, and into each input line 80A, 82A, 84A, and 86A, respectively, of parts 80, 82, 84, and 86, and into each of parts 80, 82, 84, and 86.

A water source 92 applies water through line 92A. Water source 92 can be any suitable source such as a water tank or water provided by a utility water source available in shop piping. Water valve 68 does not send water to first manifold 64 when valve 68 is closed. Water is sent to first manifold 64 when valve 68 is open. The water is then directed through line 72 to common line 74 and into each input line 80A, 82A, 84A, and 86A, respectively, of parts 80, 82, 84, and 86, and into each of parts 80, 82, 84, and 86.

A hot water source 94 may be used if the sealant being used is thermally cured. The hot water source may be any suitable structure or source, such as a hot water tank. The hot water should preferably have a temperature between 85° C. and 100° C., or about 90° C.-95° C., or between 85° C. and 100° C., although water at any suitable temperature to cure the sealant may be used. Hot water source 94 applies hot water through line 94A. Hot water valve 96 does not send hot water to first manifold 64 when valve 96 is closed. Hot water valve 96 sends hot water to first manifold 64 when valve 96 is open. When hot water is sent to first manifold 64 the hot water is directed to common line 74 and to each of input lines 80A, 82A, 84A, and 86A, respectively, of parts 80, 82, 84, and 86, and into each of parts 80, 82, 84, and 86.

Any suitable number of lines, such as line 72, may connect first manifold 64 to input lines 80A, 82A, 84A, and 86A. For example, there may be a separate line from first manifold 64 to each of input lines 80A, 82A, 84A, and 86A for each of vacuum, pressure, water, and hot water (if hot water is used). Or there may be a line for two or more of vacuum, pressure, water, and hot water (if hot water is used) and a separate line or lines for the other inputs to input lines 80A, 82A, 84A, and 86A. Additionally, if properly controlled, vacuum pump 10, pressure source 90, water source 92, and (if used) hot water source 94 could directly supply input lines 80A, 82A, 84A, and 86A.

The sealant reservoir 52 is a 250-gallon intermediate bulk carrier (IBC) tank from which sealant is drawn, but reservoir 52 can be any suitable structure and hold any suitable volume of sealant. A sealant is passed from sealant reservoir 52 through a line 52A to a second manifold 58, and the passage of the sealant is controlled by sealant valve 56. When sealant valve 56 is closed, no sealant flows from sealant reservoir to second manifold 58. When sealant valve 56 is open, sealant flows to second manifold 58 where it is directed to line 70 and to common line 74, and then to input lines 80A, 82A, 84A, and 86A to inject sealant (or push the sealant into) the pathways and porosities of each of respective parts 80, 82, 84, and 86.

Further, any suitable number of lines, such as line 72 may connect second manifold 58 to input lines 80A, 82A, 84A, and 86A. For example, there may be a separate line from second manifold 58 to each of input lines 80A, 82A, 84A, and 86A for providing sealant. Additionally, if properly controlled, sealant reservoir 52 could directly supply input lines 80A, 82A, 84A, and 86A.

Output lines 80B, 82B, 84B, and 86B are used to drain excess liquid sealant and drain water from parts 80, 82, 84, and 86. As shown, excess sealant and the water are drained through line 70, through second manifold 58, through drain valve 54 and into a storage tank 96, which can be any suitable structure of any suitable volume. Although the excess liquid sealant and water can be drained in any suitable manner. Excess air is vented through outlet lines 80B, 82B, 84B, and 86B through line 72, first manifold 64, and past vent valve 66, although excess aur can also be vented in any suitable manner.

In one embodiment of a process using system 50, vacuum is first applied to parts 80, 82, 84, and 86 to clean the porosities in the parts and pressurize them. The vacuum can be of any suitable amount, such as 6.5 m Bar, or between 0-27 m Bar. While the vacuum is maintained (although it used not to be maintained), sealant is then applied from the sealant reservoir 52 through sealant valve 56, second manifold 64, line 70, common line 74, and into the porosities of parts 80, 82, 84, and 86. If vacuum is still maintained it helps to draw the sealant into the porosities of the parts.

Next, high pressure air, which may be applied at 60 psi-90 psi, or at any suitable pressure, is applied to the parts 80, 82, 84, 86 through first manifold 64 and input lines 80A, 82A, 84A, and 86A. The high pressure air may over pressure the inner porosities of the parts by 1 Bar or greater, or up to about 5.5 Bar total, or from 1 Bar to 20 Bar, which further drives the sealant into the porosity of the parts. The high pressure air can later be vented through outlets 80B, 82B, 84B, and 86B and back through line 72 to first manifold 64, and through vent valve 66. Alternatively, the high pressure air could be vented through a line other than line 72 and need not pass through first manifold 64.

When the inside of the parts are sufficiently impregnated with sealant, the over pressure is removed so the pressure returns to atmospheric.

The sealant may be a methacrylate-based monomer that is thermally cured. It may have a viscosity of 12 centipoise and contain no acid. It may include a trifunctional monomer. The sealant may also be an anaerobic and need no heat to cure. If the sealant must be cured at a high temperature, hot water (or another fluid such as a suitable oil) may be introduced into the porosities of parts 80, 82, 84, and 86 by hot water source 96 through hot water valve 98, first manifold 64, and ultimately input lines 80A, 82A, 84A, and 86A. The hot water may have a temperature of about 85° C.-95° C., 90° C.-95° C., 95° C.-100° C., or 90° C.-225° C. The hot water remains in parts 80, 82, 84, and 86 for a sufficient time to cure the sealant. Target cure times can be 1.6-2.4 minutes, less than 10 minutes, or 10-40 minutes for both thermally-cured sealant and anaerobic sealant.

If hot water is used it can be removed by, for example, applying pressurized air which forces the hot water out of output lines 80B, 82B, 84B, and 86B and ultimately through second manifold 58, past drain valve 54 and into drain basin 96. The high pressure air is preferably vented through vent valve 66.

### Process Example 1

An embodiment of a process sequence utilized by a system of this disclosure is as follows:

(1) An operator or robot places the part to be sealed into a fixture, or the part remains in a dunnage.

(2) Process lines (a first fluid line, or fill line, and a second fluid line, or drain line) are connected to the part to be sealed.

(3) A vacuum pump is turned on and dry vacuum is preferably applied to the part via the first fluid line.

(4) A vacuum setpoint, or amount, is reached.

(5) The vacuum valve is closed, which stops the application of the vacuum through the first fluid line to the part.

(6) The dry vacuum is held in the part for 1-999 seconds.

(7) A sealant reservoir transfer valve is opened.

(8) A sealant is transferred into the part, preferably via the second fluid line, using the vacuum energy as suction to draw the sealant into the part's inner porosities.

(9) A sealant level sensor determines the amount of sealant in the part. The amount of sealant to be placed inside of the part may be first determined by manual trial and error to determine how much sealant is required to properly seal the part.

(10) The vacuum valve is re-opened to apply wet vacuum (wet because the sealant is present) to the part via the first fluid line.

(11) A wet vacuum setpoint is achieved.

(12) The vacuum valve is closed.

(13) The wet vacuum setpoint is held from 1-999 seconds.

(14) A pressure valve is opened.

(15) The internal porosity of the part is pressurized, preferably by passing pressurized air via the first fluid line into the part, to a customer directed set point, which varies from part to part. The pressure could be in a range from 50 psi-90 psi while the sealant is in the part, or be any suitable pressure.

(16) The pressure is held for 1-999 seconds.

(17) The pressure hold is completed and the pressure valve is closed.

(18) The sealant valve is opened.

(19) The pressure in the part returns the unused, uncured sealant to the sealant reservoir via the second fluid line.

(20) The sealant valve is closed.

(21) A water valve is turned on and hot water flows, preferably through via the first fluid line, though the same connection point as the pressurized air did.

(22) The hot water sequence is from 1-999 seconds, or any suitable time, which is until the sealant inside of the part is cured.

(23) The hot water valve is closed.

(24) The pressure valve opens and pressurized air moves through the first fluid line into the part.

(25) The pressurized air is driven though the part to both push the water out of the part through the second fluid line and dry the internal porosities of the part.

Curing the sealant could be done using two possible methods: (1) at the conclusion of step 22 hot water (e.g., at any suitable temperature, such as 195° F.) can be pumped through the part to cure the sealant; or (2) at the conclusion of step 22, if an anaerobic sealant is used (which cures in absence of air). The part can then be palletized after the cure.

Parameter Comparison of SPI Versus Standard
Batch Process For Aluminum or Magnesium Parts

| | | Standard Process |
|---|---|---|
| Vessel | SPI Value | Value |
| Vacuum Level (mBar) | 6.5 mBar | 6.5 mBar |
| Time to vacuum (seconds) | 5 | 50-1200 |
| Time to pressure (seconds) | 600 | 4-180 |
| Time to wash (seconds) | 5.5 | 70-600 |
| Time to Cure (seconds) | 120 (or 0) | 150-1200 |
| Total in process material | 0 | 60-120 |
| handling (seconds) | | |
| Total material packing- | 0 | Up to 1200 |
| offline (seconds) | | |
| Total cycle time (seconds) | Sub 180 | 1200-10,800 |
| Upper Chamber Volume | 0 | 250-3500 |
| sealant (gallons) | | |
| Upper Chamber Volume | 0 | 250-3500 |
| sealant (gallons) | | |
| CW/CCW Rotation (RPM) | 0 (not required) | 11-250 |

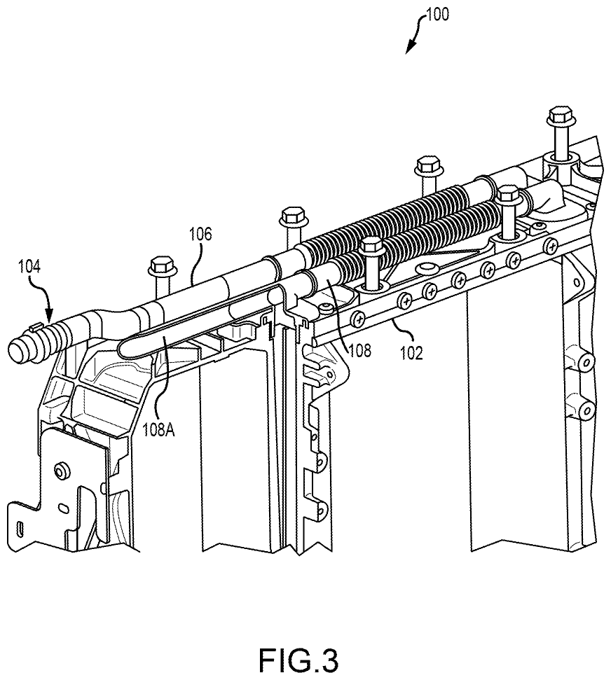

FIG. 3 depicts an example of an SPI project. Here, process fluids (such as vacuum, pressurized air, water, sealant, and optionally hot water) are passed through one or two tubes (or lines) 106, 108 and inside of an internal structure of part 102 in order to impregnate and seal the porosities of the part 102. In this case, the connection 104 type is called a VDA connection. Any connection type, however, can be utilized. Examples of connection types that can be used with the systems and processes of this disclosure are VDA, hose barb, cam lock, NPT, BSPT, BSPP, NPTF, JIS, JIC, SAE (all variants), sanitary/tri-clamp or simply a nozzle that plugs into the part 102 or other part. Structure 108A is a cut-away view showing the interior of tube 108.

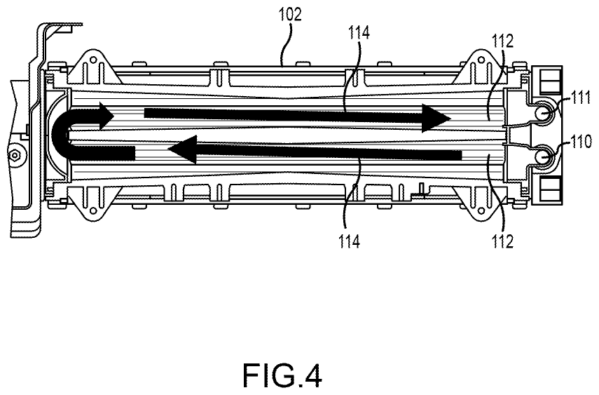

FIG. 4 shows a sectional top view of the part 102. Opening 110 depicts the inlet, which in this case is connected to connection 104, for part 102 to which tube 106, shown in FIG. 3, connects. The arrows 114 represent the path the fluid travels inside the casting pathway 112 of part 102. This path 112 is rather simplistic for sake of illustration. There can be dozens of such paths in a large casting that are more complex and lengthy. The fluid outlet for part 102 is opening 111.

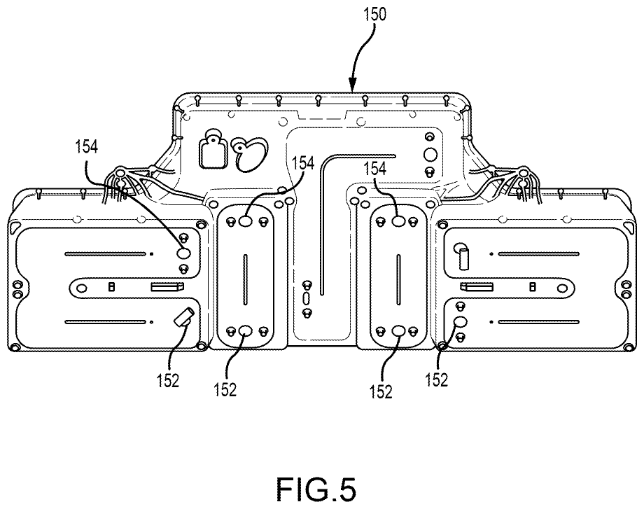

FIG. 5 shows an example of a more complex part, which is a battery tray 150, wherein the openings, including stem 152, are the inlets for fluids to enter the porosities to battery tray 150 and openings 154 are the outlets for the fluids. Part 150 features both casting opening inlet/outlets 152, 154 as well as one inlet 152 with a hose barb style connection.

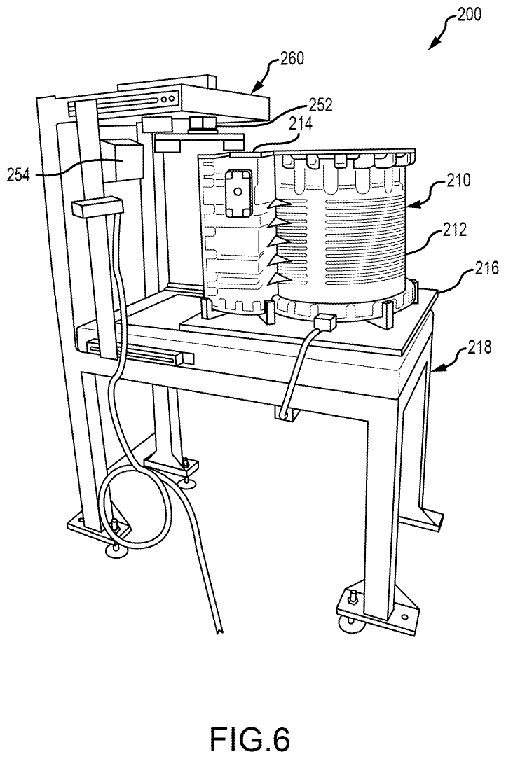

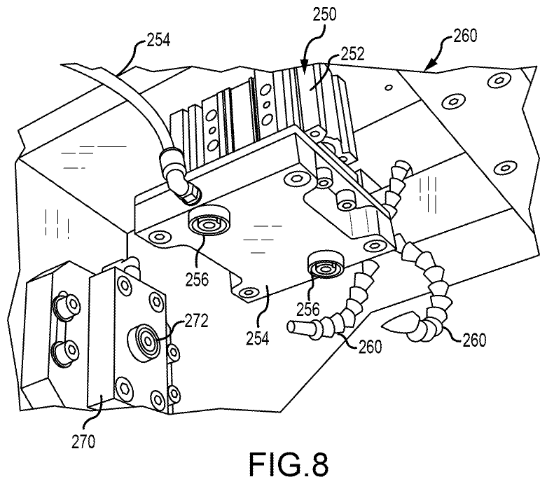

FIGS. 6-8 show an SPI system and process of this disclosure that can be used to impregnate and seal large castings by identifying openings to a part 210, such as a casting, and custom designing a support 218 and manifolds 252, 254 to mate with openings to the part. In this case openings 222 to three known leak paths are targeted on the part 210 and the sealant impregnation can be repeated for numerous of the same parts. The system 200 for the part 210 is specifically configured to process multiple parts 210, and includes a first manifold 252 and a second manifold 254. Manifolds 252 and 254 are attached at specific positions on support 218 so their ports 256 and 272 (shown in FIG. 8) align with and mate with the leak holes (or openings) 222 on part 210. Support 218 has a servo platform 216 that moves outwards (in the position shown) and inwards so the openings 222 align with and mate with ports 256 and 272 on manifold 252 and 254, respectively. Support 218 also has an upper portion 260 to which manifold structure 250 is attached.

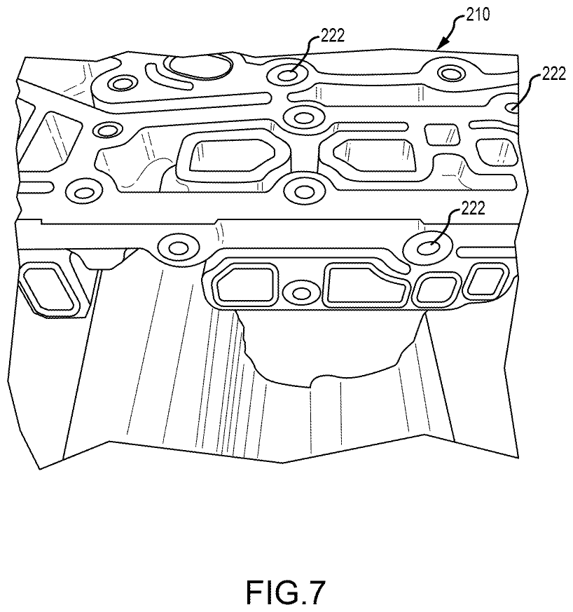

FIG. 7 is a partial perspective view showing part of the top and part of the rear of part 210 and showing openings 222 to the leak paths.

FIG. 8 shows a partial, side perspective view of support 218 with manifolds 252 and 254. Manifold 254 is attached to a cylinder 252 that as shown is in its first upward position. When part 210 is moved backwards by servo platform 216, port 222 at the back of part 210 is aligned with and receives port 272 of manifold 254. The cylinder 252, which can be a hydraulic or pneumatic cylinder, or any type of device to move manifold 254 up and down, moves manifold 254 down so ports 256 engage and are received in openings 222 on the top of part 210. The manifolds 252, 254 can seal against the cast surface of part 210 in any suitable manner, such as with a gasket or o-ring and the process fluids to the manifolds 252, 254 would all flow through tubes, such as tube 256. Hoses 262 are not attached to the manifold and can be used to dry or clean the outer surface of part 210.

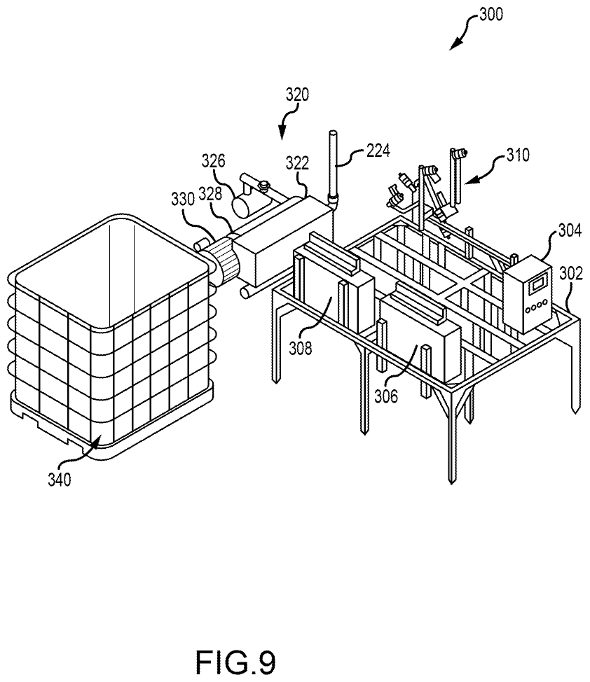

FIG. 9 shows an alternate system according to this disclosure that is configured to seal two parts 306, 308 at one time. A sealant container 340, a vacuum pump 330, a compressed air source 326, and a water source 322 are shown. Using valve structure 310 and controller 304 the different inputs, and timing of method steps required to seal parts 306 and 308 can be automatically performed.

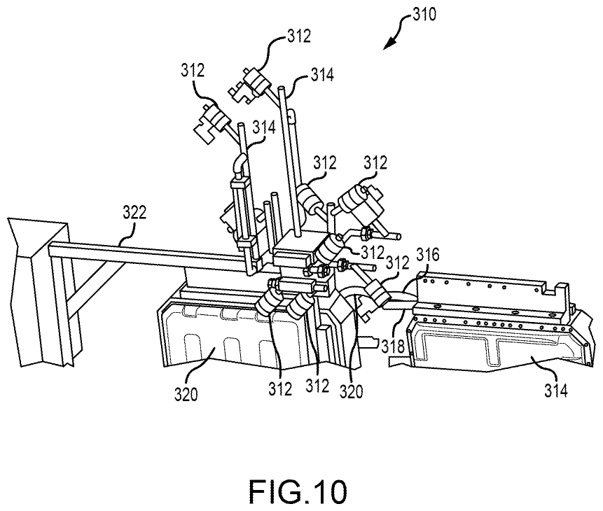

FIG. 10 shows the valve tree 310 of the system of FIG. 9. A holding vessel 314 of sealant for one operation may include a transparent plate so an operator knows when a full dose of sealant has been delivered to one or both parts 306, 308. The amount to be provided may have been determined by manual trial and error before the process is automated and be based on customer specifications for an acceptable leakage amount at certain air pressures.

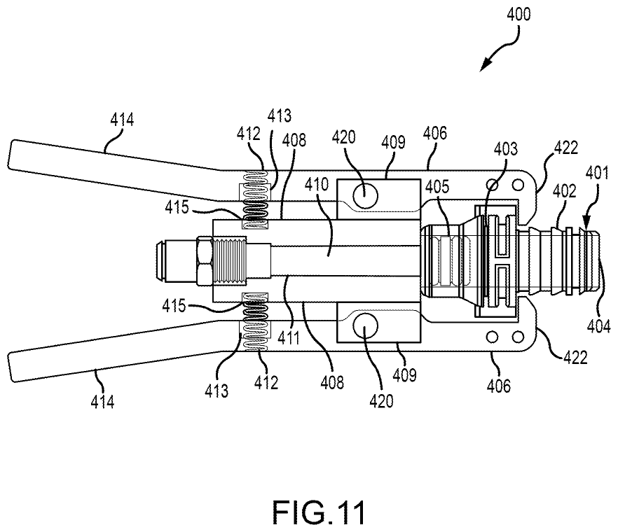

FIG. 11 shows a manual VDA connector 400 to facilitate quick clamping of input lines and output lines to a part. All process fluids could flow though such a connector, although any suitable connector could be used. Connector 401 has a nozzle 402 and an opening 404. One or more o-rings 403 seal the nozzle 402 with another surface. Nozzle 402 has a passage 405 that leads to a passage 410 in a nozzle body portion 411. These aspects of nozzle 400 are known, as is the nut connection at the nozzle 401's end opposite opening 404.

Two hand (or finger) operated arms 406 are connected to a cylindrical body 408 that slides over the body of nozzle 401. Cylindrical body 408 has flanges 409 that connect to arms 406 by fasteners 420. Each arm 406 has a spring 412 received in an opening 413 and attached to arm 416 at the base of opening 413. Each spring is further received in a respective opening 415 on either side of the cylindrical body 408. Each arm 406 has a flared portion 414 and a gripping portion 422. When in use, an operator grasps the flared portions 414 of each arm 406 with his/her hand or fingers and moves them inwards towards one another to a second, expanded position. Springs 412 compress and gripping portions 422 move outward and apart in the second, expanded position. Then nozzle end 402 is inserted into an opening of a stem on a part. The operator then releases flared portions 414 of arms 406 and the gripping portions 422 move to the first, compressed position and grasp the outer surface of the stem to help secure the nozzle 401. The nozzle 401 is removed by an operator by again grasping and pushing together flared portions 414 of arms 406 which moves grips 422 apart and nozzle 401 can be removed from the stem.

The process parameters above compare SPI of this disclosure to a machine and batch system that would handle large aluminum castings, such as a battery tray. It also includes an estimate of the fastest theoretical SPI process times. For the batch process a 48″ diameter basket is packed with parts and crane material handling is required.

Some non-limiting examples of this disclosure are recited below:

Example 1: A method for vacuum impregnating a porosity of a part with sealant without immersing the part in the sealant, wherein the method comprises the following steps:
(a) connecting a first fluid line to the part, wherein the first fluid line is in communication with the porosity;
(b) connecting a second fluid line to the part, wherein the second fluid line is in communication with the porosity;
(c) drawing a vacuum through the first fluid line and through the porosity; and
(d) releasing sealant through the second fluid line and into the porosity.

Example 2: The method of example 1 that further comprises the step of stopping the vacuum applied through the first fluid line after the vacuum has reached a predetermined level and before the sealant is released.

Example 3: The method of example 1 or example 2 that further comprises the step of re-applying vacuum through the first fluid line after the sealant has been released and has entered the porosity.

Example 4: The method of example 1 that further comprises the step of applying pressurized air through the first fluid line after the sealant is released into the porosity to assist in filling the porosity with sealant.

Example 5: The method of example 4 that further comprises the step of removing excess sealant through the second fluid line, wherein the excess sealant is pushed out of the part by the pressurized air or by water.

Example 6: The method of any one of examples 1-5 that further comprises the step of applying heated water into the porosity through the first fluid line in order to cure the sealant.

Example 7: The method of any one of examples 1-6, wherein the part includes a first connector connected to the part and connected to the first fluid line.

Example 8: The method of any one of examples 1-7, wherein the part includes a second connector connected to the part and connected to the second fluid line.

Example 9: The method of any one of examples 1-8, wherein the part is fully assembled.

Example 10: The method of any one of examples 1-9, wherein the part comprises metal.

Example 11: The method of example 10, wherein the part comprises aluminum or magnesium.

Example 12: The method of example 6, wherein the heated water is at a temperature from 80° C. to 100° C., or from 85° C. to 95° C., or from 90° C. to 95° C.

Example 13: The method of any one of examples 1-12, wherein the vacuum is 6.5 mBar, or lower than 6.5 mBar, or any amount from 0-27 mBar.

Example 14: The method of example 4, wherein the pressure is applied by shop air or air contained in pressurized tanks applied through the first fluid line.

Example 15: The method of any one of examples 4 or 14, wherein the air pressure is 30-60 psi, or 60-90 psi, and the pressure maintained inside of the part is increased by 1 Bar, any amount from 1 Bar to 5.5 Bar, or by 5.5 Bar, or any amount from 1 Bar to 20 Bar.

Example 16: The method of example 15, wherein the air pressure is 40 psi.

Example 17: The method of any one of examples 1-3 or 5-16, wherein the sealant is anaerobic.

Example 18: The method of any one of examples 1-16, wherein the sealant is anaerobic and does not require heat to cure.

Example 19: The method of example 5 or example 6 that further includes the step of removing excess water from the part through the second fluid line by pressurized air applied through the first fluid line.

Example 20: The method of example 19, wherein excess water and excess uncured sealant is pushed out of the part and into the second fluid line by pressurized air introduced into the part through the first fluid line.

Example 21: The method of any one of examples 1-20 that further includes the step of placing the part on a fixture before performing any of steps (a)-(d) of example 1.

Example 22: The method of any one of examples 1-21, wherein vacuum is applied to the part before the sealant is released until a predetermined vacuum setpoint is reached.

Example 23: The method of example 22, wherein a vacuum valve is closed after the predetermined vacuum setpoint is reached.

Example 24: The method of any one of examples 1-23, wherein the vacuum is maintained for 1-999 seconds.

Example 25: The method of example 23 or example 24, wherein a sealant reservoir transfer valve is opened after the vacuum valve is closed.

Example 26: The method of any one of examples 1-25, wherein the sealant is released into the part until a predetermined amount of sealant is in the part.

Example 27: The method of any one of examples 1-28, wherein a vacuum (a wet vacuum) is applied after the sealant is released into the part until a predetermined vacuum level is reached.

Example 28: The method of example 27, wherein the wet vacuum is maintained for 1-999 seconds.

Example 29: The method of example 4, wherein the pressure is maintained for 1-999 seconds.

Example 30: The method of any one of examples 1-29, wherein the sealant valve is reopened to permit pressurized air to push excess liquid sealant into a waste liquid reservoir.

Example 31: The method of any one of examples 1-30 that utilizes:
(a) a first manifold in communication with the first fluid line and also in communication with (i) a vacuum pump via a vacuum valve, (ii) a pressurized air source via a pressure valve, (iii) a pressurized water source via a water valve, and (iv) a vent via a vent valve; and
(b) a second manifold in communication with the second fluid line and also in communication with (i) a sealant reservoir via a sealant valve, and (ii) a drain via a drain valve.

Example 32: The method of example 31, wherein each of the valves is operated independently.

Example 33: The method of any one of examples 1-32, wherein multiple parts are simultaneously impregnated with sealant.

Example 34: The method of example 7, wherein the first connector is one of the following: VOA, hose barb, cam lock, NPT, BSPT, BSPP, NPTF, JIS, JIC, SAE, sanitary/tri-clamp or nozzle.

Example 35: The method of example 8, wherein the second connector is one of the following: VOA, hose barb, cam lock, NPT, BSPT, BSPP, NPTF, JIS, JIC, SAE, sanitary/tri-clamp or nozzle.

Example 36: The method of any one of examples 1-35, wherein the outer surface of the part is not exposed to the sealant.

Example 37: The method of any one of examples 1-36, wherein the part is not immersed in sealant.

Example 38: The method of any one of examples 1-37, wherein the part is not washed.

Example 39: The method of any one of examples 1-38, wherein the part is not washed.

Example 40: The method of any one of examples 1-39, wherein the part is not rinsed.

Example 41: The method of any one of examples 1-40, wherein the outside surface of the part is not exposed to a surfactant.

Example 42: The method of any one of examples 1-41, wherein the part remains in a dunnage while being sealed.

Example 43: The method of any one of examples 1-42, wherein the sealant is a mixture of ethoxylated monomer.

Example 44: The method of any one of examples 1-43, wherein the sealant is a methacrylate-based monomer.

Example 45: The method of any one of examples 1-44, wherein the sealant has a viscosity of 12 centipoise.

Example 46: The method of any one of examples 1-45, wherein the sealant contains no acid.

Example 47: The method of any one of examples 1-46, wherein the sealant includes a trifunctional monomer.

Example 48: The method of any one of examples 1-47, wherein the sealant is anaerobic.

Example 49: The method of any one of examples 1-48, wherein the pressure is raised to any amount from 1.1 Bar to 20 Bar or higher while the sealant is in the part.

Example 50: The method of any one of examples 1-49 that is configured to cure the sealant in less than 45 minutes.

Example 51: The method of any one of examples 1-50 that is configured to cure the sealant in 10 minutes or less.

Example 52: The method of any one of examples 1-51 that is configured to cure the sealant in any time from 10 minutes to 40 minutes.

Example 53: The method of any one of examples 1-52, wherein the part has a void fill of 95% of greater after the sealant is cured.

Example 54: The method of any one of examples 1-53, wherein the part has a gas porosity of zero after the sealant is cured.

Example 55: The method of any one of examples 1-54, wherein the first fluid line is connected to the porosity at a different location than the second fluid line is connected to the porosity.

Example 56: The method of any one of examples 1-55, wherein the first fluid line is connected to the porosity by a nozzle.

Example 57: The method of any one of examples 1-56, wherein the second fluid line is connected to the porosity by a nozzle.

Example 58: The method of any one of examples 56-57, wherein the nozzle includes two arms, wherein each arm has a gripping portion, and the arms have a first, compressed position in which the gripping portions are compressed and are configured to grasp a stem, and a second, expanded position in which an end of the nozzle can be inserted into or removed from an opening in the stem.

Example 59: The method of example 58, wherein each nozzle has a cylindrical body that is positioned over a nozzle body.

Example 60: The method of any one of examples 58-59, wherein the nozzle further includes a first spring connected to a first arm and to the cylindrical body, and a second spring connected to a second spring and to the cylindrical body.

Example 61: The method of example 60, wherein the first spring and second spring are in (a) a first, compressed position when the arms are in their first, compressed position, and (b) a second, expanded position when the arms are in their second, expanded position.

Example 62: The method of any one of examples 1-61, wherein a pressurized air source, a water supply source, and a vacuum are connected to a first manifold.

Example 63: The method of example 62, wherein there is an air pressure valve between the pressurized air source and the first manifold.

Example 64: The method of any one of examples 62-63, wherein there is a water valve between the water source and the first manifold.

Example 65: The method of any one of examples 62-64, wherein there is a vacuum valve between the vacuum source and the first manifold

Example 66: The method of any one of examples 62-65 that further includes a hot water source in communication with the first manifold.

Example 67: The method of example 66, wherein there is a hot water valve between the hot water source and the first manifold.

Example 68: The method of any one of examples 62-67, wherein there is a first supply line from the first manifold to the part(s).

Example 69: The method of any one of examples 62-68 that further includes an air exhaust line connected to the first manifold.

Example 70: The method of example 69 that further includes an air exhaust valve in the air exhaust line.

Example 71: The method of example 68, wherein vacuum, pressurized air, and water are provided to the part(s) by the first supply line.

Example 72: The method of example 69, wherein the exhausted air is sent from the part(s) to the first manifold by the first supply line.

Example 73: The method of any one of examples 1-72 that further includes a sealant supply.

Example 74: The method of example 73, wherein the sealant supply is connected to a second manifold by a sealant line.

Example 75: The method of example 74, wherein a sealant valve is positioned in the sealant line between the sealant source and the second manifold.

Example 76: The method of any one of examples 73-75, wherein a second supply line supplies sealant from the second manifold to each of the part(s).

Example 77: The method of any one of examples 73-76 that further includes a sealant and water return line between the second manifold and a drainage tank.

Example 78: The method of example 77, wherein excess liquid sealant and excess water are returned from the part(s) to the second manifold via the second supply line and then sent to the drainage tank via the sealant and water return line.

Example 79: The method of any one of examples 68-78, wherein there is more than one first supply line.

Example 80: The method of any one of examples 76-79, wherein there is more than one second supply line.

Example 81: The method of any one of examples 1-80, wherein there are a plurality first fluid lines.

Example 82: The method of any one of examples 1-81, wherein there are a plurality of second fluid lines.

Example 83: The method of any one of examples 1-82, wherein there are a plurality of parts and a plurality of first fluid lines connected to each of the plurality of parts.

Example 84: The method of any one of examples 1-83, wherein there are a plurality of parts and a plurality of second fluid lines connected to each of the plurality of parts.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A method for impregnating a porosity of a part with sealant without immersing the part in the sealant, the method comprising the following steps:
(a) connecting a first fluid line to the part, wherein the first fluid line is in communication with the porosity;
(b) connecting a second fluid line to the part, wherein the second fluid line is in communication with the porosity;
(c) drawing a vacuum through the first fluid line and through the porosity; and
(d) releasing a liquid sealant through the second fluid line and into the porosity.

2. The method of claim 1 that further comprises the step of stopping the vacuum applied through the first fluid line after the vacuum has reached a predetermined level and before the sealant is released.

3. The method of claim 1 that further comprises the step of re-applying vacuum through the first fluid line after the sealant has been released and has entered the porosity.

4. The method of claim 1 that further comprises the step of applying pressurized air through the first fluid line after the sealant is released into the porosity to assist in filling the porosity with sealant.

5. The method of claim 4 that further comprises the step of removing excess sealant through the second fluid line, wherein the excess sealant is pushed out of the part by pressurized air.

6. The method of claim 1, wherein the first fluid line includes a first connector connected to the part.

7. The method of claim 1, wherein the second fluid line includes a second connector connected to the part.

8. The method of claim 1, wherein the part is assembled and includes circuitry.

9. The method of claim 1, wherein the part comprises metal.

10. The method of claim 9, wherein the part comprises aluminum or magnesium.

11. The method of claim 1, wherein the vacuum is 6.5 mBar, or any amount from 0.1 to 27 mBar.

12. The method of claim 4, wherein the pressurized air is provided by shop air or compressed air tanks applied through the first fluid line.

13. The method of claim 4, wherein the air pressure is from 30-60 psi.

14. The method of claim 4, wherein the air pressure is maintained in the part at any amount from 1.1 Bar to 20 Bar.

15. The method of claim 1, wherein the sealant is anaerobic.

16. The method of claim 1, wherein water is applied through the first fluid line to remove excess liquid sealant by pushing it through the second fluid line.

17. The method of claim 16 that further includes the step of removing excess water from the part through the second fluid line by pressurized air applied through the first fluid line.

18. The method of claim 17, wherein excess water and excess uncured sealant is pushed out of the part and into the second fluid line by pressurized air introduced into the part through the first fluid line.

19. The method of claim 1 that further comprises the step of applying heated water into the porosity through the first fluid line in order to cure the sealant and the sealant is not anaerobic.

20. The method of claim 19, wherein the heated water temperature is from 85° C. to 95° C.
